(19) United States
(12) Patent Application Publication
(10) Pub. No.: US 2006/0142406 A1
(43) Pub. Date: Jun. 29, 2006

(54) Multicomponent, in situ foaming system for the preparation of interpenetrating polymeric networks and its use

(76) Inventors: Franz-Josef Schmitt, Munich (DE); Michael Leitner, Landsberg (DE); Ute Schnoeller, Munich (DE)

Correspondence Address: ABELMAN, FRAYNE & SCHWAB, 666 THIRD AVENUE, 10TH FLOOR, NEW YORK, NY, 10017, US

(21) Appl. No.: 11/303,327

(22) Filed: Dec. 15, 2005

(30) Foreign Application Priority Data
Dec. 23, 2004 (DE) 10 2004 062 225.6

(51) Int. Cl. C08G 18/00

(52) U.S. Cl. 521/172

(57) ABSTRACT

A multicomponent, in situ foaming system is described for the preparation of interpenetrating polymeric networks (IPN) of foamed polyurethane and at least one further polymer for in situ construction purposes with a polyisocyanate component (A) and a polyol component (B) for forming the polyurethane, and further components (C) and (D) for forming the further polymer, components (A) and (B) being present in a reaction-inhibiting, separate form, characterized in that the components (A), (B), (C) and (D) are present in the form of one or two mixtures, in which the components (A), (B), (C) and/or (D) are contained separately in a micro-encapsulated form in order to inhibit reaction so that the components polymerized with formation of the interpenetrating polymeric network only when the components are brought into contact with one another after destruction or opening of the microcapsules, the use of this multicomponent in situ foaming system for sealing openings and/or bushings in walls and/or ceilings of buildings, and a method for sealing such openings and/or bushings using this multicomponent, in situ foaming system.

### BACKGROUND OF THE INVENTION

1. Field of the Invention

The invention relates to a multicomponent, in situ foaming system for the preparation of interpenetrating polymeric networks (IPN) of foamed polyurethane and at least one further polymer for in situ construction purposes with a polyisocyanate component (A) and a polyol component (B) for forming the polyurethane, and further components (C) and (D) for forming the further polymer, components (A) to (D) being present in a reaction-inhibiting, separate form, the use of this multicomponent in situ foam system for sealing openings and/or bushings in walls and/or ceilings of buildings, as well as to a method for sealing openings and/or bushings in walls and/or ceilings of buildings using this multicomponent, in situ foaming system.

2. Description of the Prior Art

Interpenetrating polymeric networks and their preparation are known (Römpp, Lexikon Chemie, 10^{th} edition (1997), page 1945). Such interpenetrating, polymeric networks can be prepared in various ways, for example, by simultaneously polymerizing two or more different monomers in the presence of cross-linking agents. The polymerizing reaction for each of the monomers used must be specific, in that, for example, the first monomer, with the help of the first cross-linking agent, forms a polymeric network, into which the second monomer is not linked or hardly linked covalently. With the help of the second cross-linking agent, the second monomer forms a polymeric second network, which interpenetrates the polymeric first network and into which the first monomer is not linked or is hardly linked covalently. Several polymeric networks can be interlaced in one another, depending on the number of different monomers and their different types of polymerization.

The essential property of such interpenetrating, polymeric networks is seen to lie therein that the polymer networks formed penetrate one another mutually, there being no or only little chemical bonding between different networks. Because of the mutual penetration and their cross-linking, the interpenetrating, polymeric systems can no longer demix. This results in systems of particularly high mechanical stability.

The DE 101 50 737 A1 discloses a generic multicomponent, in situ foaming system for the preparation of polyurethane foams for in situ construction purposes, with a polyisocyanate component (A) and a polyol component (B), which are present in separate containers. Aside from the polyisocyanate component (A) and the polyol component (B) for forming the polyisocyanate network, further components (C) and (D) are contained in spatially separate form, namely in separate chambers of multichamber cartridges, at least three of the components for forming the interpenetrating polymers being present in separate containers, for example, the containers of a three-component extrusion equipment. When the components are mixed, an interpenetrating polymeric network is formed from foamed polyurethane and at least one further polymer. When used as intended, the multicomponent, in situ foaming system, with the help of a delivery device with mixing head, in which the components mixed intimately, is brought into the opening and/or bushing, which is to be closed off, where the material foams and cures.

However, this conventional, in situ, multicomponent foaming systems requires the use of at least three containers for accommodating the polyisocyanate component (A), the polyol component (B) and at least one of the further components for forming the second polymer of the interpenetrating, polymeric network. Since at least three of the necessary four components must be stored in separate containers, in order to avoid undesirable reactions, and the intimate mixing of the components makes expensive equipment necessary for the intended in situ use, the object of the present invention is based on shielding the reactive, necessary components of a multicomponent, in situ foaming system for the preparation of interpenetrating polymeric networks from foamed polyurethane and at least one further polymer for in situ construction purposes in a different way from one another and, with that, to prevent reaction between the reactive components during storage and, at the same time, to achieve that the starting materials for the interpenetrating network can be extruded with conventional extrusion equipment foam one or at most two containers, without disadvantageously affecting the physical or chemical properties, which determine the use of the in situ formed foam.

Surprisingly, it has turned out that this objective can be accomplished owing to the fact that the polyisocyanate component (A), the polyol component (B) and the further components (C) and (D) for forming the further polymer are present in the form of one or two mixtures, in which the component or components, which are capable of reacting with one another, are kept separate from one another in a micro-encapsulated, reaction-inhibiting form in such a manner, that the polymerization of the components with formation of the interpenetrating, polymeric network takes place only after the components are brought into contact with one another by destruction or opening of the microcapsules.

### OBJECT OF THE INVENTION

The object of the invention therefore is the multicomponent in situ foaming system of claim 1. The dependent claims relate to preferred embodiments of this inventive object, as well as to the use of this multicomponent, in situ foaming system for sealing openings and/or bushings in walls and/or ceilings of buildings, as well as to a method for sealing such openings and bushings.

### SUMMARY OF THE INVENTION

The inventive, multicomponent, in situ foaming system of the type given above is characterized owing to the fact that the components (A), (B), (C) and/or (D) are present in the foam of one or two mixtures, in which the components (A), (B), (C) and (D) are contained separately in micro-encapsulated, reaction-inhibiting form in such a manner, that the polymerization of the components with formation of the interpenetrating, polymeric network takes place only after the components are brought into contact with one another with destruction or opening of the microcapsules.

In the inventive, multicomponent, in situ foaming system, the components (A), (B), (C) and (D), which can react with one another, are present in such a manner that, during storage, these components do not react with one another. Instead, this reaction sets in only when all components are brought into contact with one another by destruction or opening of the microcapsules.

Pursuant to the invention, it is therefore necessary that, when two of the components (A) to (D), which are capable of reacting with one another, are contained in one or the same mixture, at least one of these components must be present in a micro-encapsulated form, in order thus to prevent these components from reacting with one another. This means that these components are separated to inhibit reaction.

In accordance with one embodiment of the invention, all components (A), (B), (C) and (D) are present in the form of a single mixture, in which at least one of the components (A) and (B) is present in micro-encapsulated form to form the polyurethane network and at least one of the components (C) and (D) is present in micro-encapsulated form to form the second, interpenetrating polymer. This embodiment of the invention makes it very simple storage possible and enables the multicomponent, in situ foaming system to be used in only one container, for example, a pressure cartridge or pressure container in a conventional single chamber extrusion device.

In accordance with a second embodiment, the invention relates to a multicomponent, in situ foaming system, for which the components (A), (B), (C) and (D) are present in the form of two mixtures, which are contained in separate containers, one mixture containing the component (A) and the other mixture the component (B), and the components (C) and (D) being contained together or separately in these mixtures, the component, reacting with the constituent or constituents of the respective mixture, being present in micro-encapsulated form. For this embodiment, the components are present in the form of two separate mixtures in two separate containers, for example, a conventional, two-chamber extrusion device, so that it is not necessary to have at least three of the reactive components in micro-encapsulated form. For this embodiment, it is sufficient if, for example, the polyisocyanate component (A) is present in a first mixture in a first container and the polyol component (B) for forming the polyurethane is present in the second mixture in a second, separate container. The further components (C) and (D) may be present together in one of the two mixtures, each of these two components (C) and (D), which could react in the two mixtures, being present in micro-encapsulated form.

In accordance with a further preferred embodiment, at least one of the components (C) and (D) for forming the further polymer is present in micro-encapsulated form to inhibit reaction separately in the polyisocyanate component (A) and/or the polyol component (B). In accordance with this embodiment, the two components (C) and (D) may also be contained separately in the polyisocyanate component (A) or the polyol component (B).

For the inventive, multicomponent, in situ foaming system, it is necessary that the components (A) to (D), present in micro-encapsulated form, be present in microcapsules, which are resistant during storage to the components of the respective mixture surrounding them and release their contents only during the mixing of the components and/or during the reactions, which then take place with formation of the further polymer.

In accordance with a preferred embodiment of the invention, the components (A) to (D), present separately to inhibit reaction in micro-encapsulated form, are contained in microcapsules, which, when the multicomponent, in situ foaming system is used as intended, are destroyed by the action of mechanical forces and/or by an increase in temperature and release their contents. In this connection, the microcapsules may be formed in such a manner, that they are destroyed under the action of the forces, which occur during the extrusion of the components of the multicomponent, in situ foaming system through a conventional mixing nozzle with static mixer, by means of which the reactive components, present in the microcapsules, are released into the mixture and react with the corresponding further components, also present in the mixture and optionally also released from microcapsules to form the corresponding polymer.

In accordance with a preferred embodiment, the microcapsules are formed so that their contents are released under the action of the heat of reaction of the polyurethane-forming reaction. In accordance with this embodiment, the microcapsules are formed from a wall material, which softens, melts and breaks up or decomposes at the reaction temperature of the polyurethane-forming reactions. The microcapsules may, for example, be burst open or broken up under the action of the internal pressure resulting from the expansion behavior of the encapsulated contents. In a particularly preferred manner, the microcapsules are formed from a wall material with a softening, melting or decomposition temperature of 30° C. to 160° C. and preferably of 70° C. to 90° C.

As wall material, the microcapsules may comprise an animal, vegetable or synthetic wax or fat or an organic, polymeric material, preferably selected from paraffins, polyolefins, polystyrenes, polyesters, polyethers, polyamides, polyamines, vinyl polymers, poly(meth)acrylates, polycarbonates, thermoplastic polyurethanes, amino resins, epoxide resins, polyurethanes, unsaturated polyester resins, phenolic resins, melamine resins, halogen-containing polymers, such as polyvinylidene chlorides, polyaryl resins, polyacetals, polyimides, cellulose derivatives, alginates, alginate derivatives, gelatines, gelatine derivatives, partially crystalline polymers, copolymers on the basis of the monomers, forming the above polymers, and mixtures of these materials.

Furthermore, it is possible to form the wall of the microcapsules in the form of multilayer walls of different materials of the components given above.

In a particularly advantageous manner, the wall material of the microcapsules comprises a paraffin wax, polyolefin wax or polyester wax, which softens or melts during the mixing of the components of the multicomponent, in situ foaming system and, during the mixing of the components, releases the contents of the microcapsules in this manner.

Preferably, the microcapsules comprise 1 to 90% by weight and especially 25 to 35% by weight of the wall material and correspondingly 99 to 10% by weight and preferably 75 to 65% by weight of the capsule contents containing the components (A) to (D).

The microcapsules, which are used pursuant to the invention and in which the components (A) to (D) are contained, are prepared by known methods by coating the components, present in the form of fine droplets in the liquid or solid state, with suitable wall materials, which are given above, for example, by coating them with film-forming polymers, which are deposited after emulsification and coacervation or by interfacial polymerization on the finely divided material, which is to be enveloped. For this purpose, known coextrusion and drop pelletizing methods are used, with which the capsule contents and the wall material are extruded or formed into drops through concentric nozzles, the wall material being supplied through the external nozzle and the core material through the internal nozzle. The capsules or droplets, formed in this manner, are cured in a subsequent cooling or drying segment or the like. For this method, the ratio of wall material to core material can be adjusted by the ratio of pressures in the corresponding supplying pipelines.

With respect to further information concerning these and similar methods for the production of the micro-encapsulated components, used pursuant to the invention, reference is made to Römpp, Lexikon Chemie, 10th edition (1998), 2685 and to Ullmann's Encyclopedia of Industrial Chemistry, 5th edition (1990), 575-588 and to the publications cited therein.

Preferably, as component (C), the microcapsules contain a conventional epoxide resin and/or a siloxane prepolymer, the epoxide resin and/or the siloxane prepolymer being present in an amount of 10 to 50% by weight and preferably of 15 to 35% by weight, based on the weight of the components (A) to (D) of the in situ foaming system, in which component (C) is contained.

Component (C) preferably contains an epoxide resin with an epoxy equivalent weight of 100 to 500 g/mole and preferably of 150 to 200 g/mole. Especially preferred are epoxide resins based on 70% of bisphenols A and 30% of bisphenols F. Epoxide resins of this type and the curing agents required for them are known and commercially available.

In accordance with a further preferred embodiment, the multicomponent, in situ foaming system contains, as component (C), a siloxane prepolymer with an average molecular weight of 200 g/mole to 10,000 g/mole and preferably of 400 g/mole to 3000 translational and 2 to 4 and preferably 2 to 3 reactive end groups, especially low molecular weight alkoxy end groups and alkyl end groups, preferably methoxy end groups.

Preferably, the multicomponent, in situ foaming system contains, as component (D) for forming the further, interpenetrating polymer on the basis of an epoxide resin, a conventional catalyst for the polymerization of the epoxide resin, preferably a tertiary amine, a Lewis acid, more preferably a phenol, especially 2,4,6-tris(dimethylaminomethyl)-phenol, this catalyst optionally being contained in micro-encapsulated form with the above-addressed properties and wall materials of the microcapsules.

For forming the further polymers on the basis of a siloxane prepolymer, the inventive multicomponent, in situ foaming system contains, as component (D), preferably a conventional cross-linking agent for the siloxane prepolymer, preferably an organosiloxane with at least three methoxy end groups per molecule. This component is also optionally present in micro-encapsulated form, as explained above.

Preferably, the polyisocyanate component (A) of the inventive multicomponent, in situ foaming system comprises at least one polyisocyanate with an NCO content of 5 to 55% and preferably of 20 to 50%, and an average of 2 to 5 and preferably of 2 to 4 NCO groups per molecule. Particularly preferred polyisocyanates are those based on methylene diphenyl diisocyanate and/or polymeric homologs thereof, particularly those with an NCO content of 31% and, on the average, 2.7 NCO groups per molecule.

Preferably, the polyol component (B), present in the inventive multicomponent, in situ foaming systems, comprises at least one polyol with a hydroxyl number of 30 to 1000 and preferably of 500 to 1000 and an average hydroxy functionality per molecule of 2 to 7 and preferably of 2 to 4.

The polyol component (B) of the inventive multicomponent, in situ foaming system comprises preferably at least one polyether polyol and/or polyester polyol with a hydroxy number of 300 to 1000 and preferably of 500 to 1000 and an average hydroxy functionality of 2 to 7 and preferably of 2 to 4 and/or at least one amino polyether polyol and/or one polyol based on phosphate esters with a hydroxy number of 30 to 1000 and preferably of 100 to 300 and an average hydroxy functionality per molecule of 2 to 7 and preferably of 3 to 5.

Preferably, the characteristic number of the polyurethane reaction ranges from 95 to 165 and especially from 102 to 120. The characteristic number of the polyurethane reaction is understood to be the percentage relationship of the isocyanate groups used (amount of material of the effectively used isocyanate groups; nNCO) to the active hydrogen functions used (amount of material of the effectively used active hydrogen functions: nactiveH), which are supplied, for example, by hydroxy groups of polyols, by amino groups of amines or by carboxyl groups of carboxylic acids. An equivalent amount of isocyanate corresponds to the characteristic number of 100. A 10% excess of isocyanate groups corresponds to the characteristic number of 110. The characteristic number is obtained by dividing the value nNCO by nactiveH and multiplying by 100.

Preferably, the polyol component (B) of the inventive multicomponent, in situ foaming system contains water as blowing agent in an amount, which results in a polyurethane foam with a foam density of 0.05 to 0.5 g/cc and preferably of 0.2 to 0.4 g/cc, one or more catalysts for the polyurethane-forming reaction, the component (D) for forming the further, interpenetrating polymer and optionally a foam cell stabilizer.

In accordance with a preferred embodiment of the invention, the polyol component (B) of the inventive multicomponent, in situ foaming system contains, as catalyst for the polyurethane-forming reaction, one or more conventional, tertiary amine catalysts, preferably dimorpholine diethyl ether.

A further variation consequently contains the polyol component (B) of the inventive multicomponent, in situ foaming system as component (D) for the formation of the further, interpenetrating polymer based on an epoxide resin, a conventional catalyst for the polymerization of epoxide resins, preferably a tertiary amine, a Lewis acid, especially a phenol and, more particularly, 2,4,6-tris(dimethylaminomethyl)-phenol.

In accordance with a different embodiment, the polyol component (B) of the multicomponent, in situ foaming system contains, as component (D) for the formation of the further polymer based on a siloxane prepolymer, a conventional cross-linking agent for such siloxane prepolymers, preferably an organosiloxane with at least three methoxy groups per molecule.

Furthermore, the polyol component (B) may contain a polysiloxane as foam cell stabilizer.

It is, of course, possible that the components (A), (B), (C) and/or (D) of the inventive, multicomponent, in situ foaming system contain conventional fillers, auxiliary material and/or additives in the usual amounts, reactive additives of this type optionally also being present in a micro-encapsulated form.

The inventive, multicomponent, in situ foaming system may contain in the mixture or mixtures is 0 to 40% by weight and preferably 1 to 20% by weight of a filler selected from sand, chalk, perlite, carbon black or mixtures thereof, 0 to 2% by weight and preferably 0.1 to 1% by weight of one or more pigments or dyes and/or 0 to 40% by weight and preferably 1 to 20% by weight of a flame retardant additive, in each case based on the weight of the in situ foaming system.

Preferably, the mixtures of the inventive multicomponent, in situ foaming systems, containing the components (A) to (D), are present in one or two separate containers, which is or are connected over supplying pipelines with a delivery device with mixing head, for mixing the components (A) to (D) and bringing them into contact with one another, and for discharging the foaming reaction mixture formed. Preferably, the delivery device comprises a mixing head in the form of a nozzle with a static mixture. Advantageously, the container or containers may be provided with extrusion devices for discharging the mixtures containing the components (A) to (D) into the mixing head of the delivery device.

In this connection, it may be of advantage if the mixing head of the delivery device has a column-shaped lattice, at which the microcapsules, pressed through the lattice, are cut open or are broken up by the shear forces that arise.

The extrusion devices may be mechanical pressing devices and/or a propellant gases, which are contained in the polyisocyanate component (A) and the polyol component (B) and/or in the pressure chamber of a two-chamber cartridge.

The invention furthermore relates to the use of the inventive multicomponent, in situ foaming system for sealing openings and/or bushings in walls and/or ceilings of buildings.

The invention furthermore relates to a method for sealing such openings and/or bushings in walls and/or ceilings of buildings. The method consists therein that the multicomponent, in situ foaming system of the above-defined type, with destruction of the microcapsules containing the micro-encapsulated components (A) to (D), with the help of the delivery device with mixing head, in which the components are mixed, brought into the opening and/or the bushing, and, with formation of an interpenetrating, polymeric network (IPN) of foamed polyurethane and at least one further polymer, are foamed and permitted to cure.

The following example and comparison example explain the invention further.

### EXAMPLE AND COMPARISON EXAMPLE

### Example

The constituents, given in the following Table 1, were used for producing the inventive, multicomponent, in situ foaming system:

TABLE 1

| Material | Component | Description | Specification | Weight |
|---|---|---|---|---|
| Polyisocyanate | (A) | Based on methylene diphenyl | NCO content: 31% | 16 g |
| | | diisocyanate (MDI) and | average number of NCO | |
| | | polymeric homologs of MDI | groups per molecule: 2.7 | |
| Polyol 1 | (B) | Amino polyether polyol | OH number: 480 | 3.5 g |
| | | | average number of OH | |
| | | | groups per molecule: 4 | |
| Polyol 2 | (B) | Brominated polyether polyol | OH number: 270 | 9.5 g |
| | | | average number of OH | |
| | | | groups per molecule: 3.4 | |
| Polyol 3 | (B) | Alkyl polyol | OH number: 51 | 2.5 g |
| | | | average number of OH | |
| | | | groups per molecule: 2 | |
| Polyol 4 | (B) | Polyol based on phosphate | OH number: 130 | 4.75 g |
| | | esters | average number of OH | |
| | | | groups per molecule: 2 | |
| Microcapsules | (C) | Ester wax capsules with | Epoxy equivalent weight: | 9 g |
| with epoxide | | epoxide resin based on | 177-182 g/mole | |
| resin | | bisphenol A and bisphenol F | | |
| Water | | | OH number: 3125 | 0.15 g |
| Catalyst 1 | | Dimorpholine diethyl ether | | 5.5 g |
| Catalyst 2 | (D) | 2,4,6-Tris(dimethylamino- | | 0.2 g |
| | | methyl)-phenol | | |
| Cell Stabilizer | | Polysiloxane | | 1 g |

A first mixture is formed by mixing the polyisocyanate component (A) with the micro-encapsulated epoxide resin (component C). By mixing the polyols 1 to 4, the water, the catalysts 1 and 2 and the cell stabilizer, a second mixture is formed. The two mixtures are brought into separate containers in the form of two cartridges, which are connected over supplying pipelines with a delivery device with mixing head, in which the two mixtures are mixed.

When the inventive in situ foaming system is used, the components of the two containers are forced with the help of an extrusion device out of the cartridge over the nozzle of the mixing head and brought into the opening, which is to be filled. After the two mixtures are mixed, essentially three chemical reactions take place, namely the formation of the polyurethane, the polymerization of the epoxide resin and the foaming reaction. The temperature of the mixture increases during the exothermic formation of polyurethane. As a result, the ester wax of the microcapsules of the micro-encapsulated epoxide resin melts and the epoxide resin is released and, under the action of component (D), that is, the catalyst, polymerizes. Due to the reaction of the polyisocyanates with the polyols in the presence of the catalyst 1, the polyurethane network is formed and is foamed by the reaction of the polyisocyanate with the water present with the formation of carbon dioxide. The epoxide resin, which is cured in the presence of component (2), that is, of catalyst 2, endows the interpenetrating network with additional, advantageous properties, namely, a high hydrophobicity and good adhesion to concrete and stone.

It should be noted that mixture 1, which contains the polyisocyanates and the micro-encapsulated epoxide resin, can be stored for a sufficiently long time with out any premature reaction, so that the inventive multicomponent, in situ foaming system is outstandingly suitable for the in situ production of watertight interpenetrating, polymeric networks of polyurethane foam and epoxide resin. The foams obtained in this way, have outstanding mechanical strength properties, good water tightness and/or improved fire-protection properties.

### Comparison Example

A multicomponent in situ foaming system is produced according to the method of Example 1 from the constituents given in the following Table 2.

TABLE 2

| Material | Component | Description | Specification | Weight |
|---|---|---|---|---|
| Polyisocyanate | (A) | Based on methylene diphenyl | NCO content: 31% | 16 g |
| | | diisocyanate (MDI) with | average number of NCO | |
| | | polymeric homologs of MDI | groups per molecule: 2.7 | |
| Polyol 1 | (B) | Amino polyether polyol | OH number: 480 | 3.5 g |
| | | | average number of OH | |
| | | | groups per molecule: 4 | |
| Polyol 2 | (B) | Brominated polyether polyol | OH number: 270 | 9.5 g |
| | | | average number of OH | |
| | | | groups per molecule: 3.4 | |
| Polyol 3 | (B) | Alkylphenol | OH number: 51 | 2.5 g |
| | | | average number of OH | |
| | | | groups per molecule: 2 | |
| Polyol 4 | (B) | Polyol based on phosphate | OH number: 130 | 4.75 g |
| | | esters | average number of OH | |
| | | | groups per molecule: 2 | |
| Epoxide resin* | (C) | Epoxide resin based on | Epoxy equivalent weight: | 5 g |
| | | bisphenols A and bisphenol F | 177-182 g/mole | |
| Water | | | OH number: 3125 | 0.15 g |
| Catalyst 1 | | Dimorpholine diethyl ether | | 5.5 g |
| Catalyst 2 | (D) | 2,4,6-Tris(dimethylamino- | | 0.2 g |
| | | methyl)-phenol | | |
| Cell Stabilizer | | Polysiloxane | | 1 g |

*The amount of epoxide resin corresponds to that of the epoxide resin contained in the microcapsules of Table 1.

The two mixtures are prepared in the same manner as described in Example 1. The only difference consists therein that, in the first mixture, the epoxide resin, which is present together with the polyisocyanate, has not been micro-encapsulated. However, this mixture must be prepared immediately before use or the constituents, namely polyisocyanates, polyol and epoxide resin, must be contained in separate containers for possible storage, since the epoxide resin used cannot be combined with the polyol component, because the catalysts for the polyurethane reaction also catalyze the epoxide resin reaction and, moreover, the epoxide resin reacts with the polyol component. The corresponding applies also for the polyisocyanate component. Industrially produced epoxide resins generally are not structurally perfect mixtures of diglycidyl ethers and, instead, are oligomers of different lengths, which may also have hydroxyl groups, so that, in the presence of the polyisocyanate component, higher molecular weight compounds, which result in a mixture of higher viscosity, are formed by the urethane reaction. Moreover, the ethoxy groups of the epoxide resin can react with the polyisocyanates to form oxazolidones. Accordingly, storage experiments involving epoxide resin and isocyanate have shown that, especially at elevated temperatures (40° C.), the viscosity of the mixture increases greatly and extrusion of the mixed components from the cartridge no longer is possible. Accordingly, in the case of the multicomponent, in situ foaming system of this comparison example, the components must be mixed shortly before use or kept in at least three separate containers.

In contrast to this, the inventive multicomponent, in situ foaming system with the encapsulated epoxide resin of the inventive example enables these reactions to be avoided, since the first mixture of the polyisocyanate component (A) and the micro-encapsulated epoxide resin (component C) has an adequate shelf life, since diffusion of the epoxide resin into component C through the wall of the microcapsules is not to be expected.

To check the properties of the interpenetrating, polymeric networks, obtained from these multicomponent, in situ foaming systems, the foams, which were foamed in a beaker and cured, were investigated by means of thermogravimetric analysis. For this purpose, samples of the foams with encapsulated and with not encapsulated epoxide resin were prepared and stamped out (approximately 50 mg) and investigated in a synthetic air atmosphere by means of thermogravimetric analysis over a temperature range from 25° C. to 800° C. at a heating rate of 10° K/min and a synthetic air or nitrogen flow rate of 50 mL/min.

It was observed that the thermogravimetric analysis curves of the two multicomponent, in situ foaming system are very similar, in that the residue at 800° C. in a synthetic air atmosphere is 8.9% in the case of the not encapsulated epoxide resin and 7.5% in the case of the micro-encapsulated epoxide resin. This indicates that the interpenetrating, polymeric networks of these multicomponent, in situ foaming systems have very similar network structures.

Furthermore, thermomechanical measurements (TMA) in a synthetic air atmosphere were carried out. For this purpose, cylinders of foam, obtained in the above manner, were stamped out and the change in their length as a function of temperature was measured. Subsequently, the change in length during 20 minutes at 800° C. was observed. Within the scope of the margin of error, the TMA curves in a synthetic air atmosphere where identical in that in both materials a first large decrease in length of 36% and 40% respectively was observed at 300° C., the subsequent changes in length being almost parallel up to a temperature of 800° C.

The two samples investigated behaved very similarly with respect to the decrease in weight as a function of temperature as well as with respect to the change in length as a function of temperature, said that it may be concluded that the inventive, multicomponent, in situ foaming system provides an interpenetrating, polymeric network of foamed polyurethane with properties, which are largely identical to those of the comparison product.

However, the multicomponent, in situ foaming system of the comparison example must be stored in the form of three separate components, namely a first mixture, which contains the polyisocyanate component (A), a second mixture, which contains the polyol component (B) and a third component (C), which contains the epoxide resin. On the other hand, the inventive multicomponent, in situ foaming system can be stored in one or two mixtures because the reactive components, being in micro-encapsulated form, are kept separate to inhibit reaction. For practical purposes, this represents an appreciable advantage.

What is claimed is:

1. Multicomponent, in situ foaming system for the preparation of interpenetrating polymeric networks (IPN) of foamed polyurethane and at least one further polymer for in situ construction purposes with a polyisocyanate component (A) and a polyol component (B) for forming the polyurethane, and further components (C) and (D) for forming the further polymer, components (A) and (B) being present in a reaction-inhibiting, separate form, characterized in that the components (A), (B), (C) and (D) are present in the form of one or two mixtures, in which the components (A), (B), (C) and/or (D) are contained separately in a micro-encapsulated form in order to inhibit reaction so that the components polymerize with formation of the interpenetrating polymeric network only when the components are brought into contact with one another after destruction or opening of the microcapsules.

2. The multicomponent, in situ foaming system of claim 1, characterized in that the components (A), (B), (C) and (D) are present in the form of one mixture and that at least one of the components (A) and (B) and at least one of the components (C) and (D) is present in a micro-encapsulated form.

3. The multicomponent, in situ foaming system of claim 1, characterized in that the components (A), (B), (C) and (D) are present in the form of two mixtures, which are contained in separate containers, one mixture containing the component (A) and the other the component (B), and the components (C) and (D) being contained together or separately in these mixtures, the component, reacting with the constituent or constituents of the respective mixture, being present in micro-encapsulated form.

4. The multicomponent, in situ foaming system of claim 1, characterized in that at least one of the components (C) and (D) for forming further polymers is present separately in micro-encapsulated form to inhibit reaction in the polyisocyanate component (A) and/or the polyol component (B).

5. The multicomponent, in situ foaming system of claim 4, characterized in that the components (C) and (D) are contained separately in the polyisocyanate component (A) or the polyol component (B).

6. The multicomponent, in situ foaming system of claim 1, characterized in that the components (A) to (D), present in micro-encapsulated form, are present in microcapsules, which are stable with respect to the constituents surrounding them during storage and release their content only during the mixing of the components and/or during the reactions then taking place with formation of the further polymer.

7. The multicomponent, in situ foaming system of claim 1, characterized in that the microcapsules, containing the components (A) to (D), when the multicomponent, in situ foaming system is used as intended, are destroyed under the action of mechanical forces and/or by an increase in temperature and release their contents.

8. The multicomponent, in situ foaming system of claim 7, characterized in that the microcapsules release their content under the action of the heat of reaction of the polyurethane-forming reaction.

9. The multicomponent, in situ foaming system of claim 8, characterized in at the microcapsules are formed from a wall material, which softens, melts, breaks up or is destroyed at the reaction temperature of the polyurethane-forming reaction.

10. The multicomponent, in situ foaming system of claim 6, characterized in that the microcapsules are formed from a wall material with a softening, melting or decomposition temperature of 300 to 160° C. and preferably of 700 to 90° C.

11. The multicomponent, in situ foaming system of claims 1, characterized in that the microcapsules, as wall materials, may comprise an animal, vegetable or synthetic wax or fat or an organic polymeric material, preferably selected from paraffins, polyolefins, polystyrenes, polyesters, polyethers, polyamides, polyamines, vinyl polymers, poly(meth)acrylates, polycarbonates, thermoplastic polyurethanes, amino resins, epoxide resins, polyurethanes, unsaturated polyester resins, phenolic resins, melamine resins, halogen-containing polymers, such as polyvinylidene chlorides, polyaryl resins, polyacetals, polyimides, cellulose derivatives, alginates, alginate derivatives, gelatines, gelatine derivatives, partially crystalline polymers, copolymers on the basis of the monomers, forming the above polymers, and mixtures of these materials.

12. The multicomponent, in situ foaming system of claim 11, characterized in that the microcapsules comprise a paraffin wax, a polyolefin wax or a polyester wax as wall material.

13. The multicomponent, in situ foaming system of claim 1, characterized in that the microcapsules comprise 1 to 90% by weight and preferably 25 to 35% by weight of the wall material and correspond to 99 to 10% by weight and preferably 75 to 65% by weight of the capsule contents containing the components (A) to (D).

14. The multicomponent, in situ foaming system of claim 1, characterized in that an epoxide resin and/or a siloxane prepolymer is contained in the microcapsules as component (C).

15. The multicomponent, in situ foaming system of claim 14, characterized in that the epoxide resin and/or the siloxane prepolymer are contained in an amount of 10 to 50% by weight and preferably 15 to 35% by weight, based on the weight of components (A) to (D) of the in situ foaming system, in the component (C).

16. The multicomponent, in situ foaming system of claims 14 or 15, characterized in that an epoxide resin, with an epoxy equivalent weight of 100 to 500 g/mole and preferably of 150 to 200 g/mole is contained as component (C).

17. The multicomponent, in situ foaming system of claim 16, characterized in that an epoxide resin, based on 70% bisphenols A and 30% bisphenols F is contained.

18. The multicomponent, in situ foaming system of claims 14 or 15, characterized in that, as component (C), a siloxane prepolymer with an average molecular weight of 200 g/mole to 10,000 g/mole and preferably of 400 g/mole to 3,000 g/mole, and 2 to 4 and preferably 2 to 3 reactive end groups, especially low molecular weight alkoxy end groups and alkyl ester end groups, preferably methoxy end groups, is contained.

19. The multicomponent, in situ foaming system of claim 14, characterized in that, as component (D) for forming the further polymer based on an epoxide resin, a conventional catalyst for the polymerization of the epoxide resin, preferably a tertiary amine, a Lewis acid, preferably a phenol, particularly 2,4,6-tris(dimethylaminomethyl)-phenol is contained, optionally in a micro-encapsulated form.

20. The multicomponent, in situ foaming system of claim 14, characterized in that, as component (D) for the formation of the further polymer on the basis of a siloxane prepolymer, a conventional cross-linking agent for the siloxane prepolymer, preferably an organosiloxane with at least three methoxy end groups per molecule, is contained, optionally in micro-encapsulated form.

21. The multicomponent, in situ foaming system of claim 1, characterized in that the polyisocyanate component (A) comprises at least one polyisocyanate with an NCO content of 5 to 55% and preferably of 20 to 50% and, on the average, 2 to 5 and preferably 2 to 4 NCO groups per molecule.

22. The multicomponent, in situ foaming system of claim 21, characterized in that the polyisocyanate component (A) comprises a polyisocyanate based on methylene diphenyl diisocyanate and/or polymeric homologs thereof.

23. The multicomponent, in situ foaming system of claim 22, characterized in that the polyisocyanate component (A) comprises a polyisocyanate based on methylene diphenyl diisocyanate and/or polymeric homologs thereof with an NCO content of 31% and, on the average, 2.7 NCO groups per molecule.

24. The multicomponent, in situ foaming system of claim 1, characterized in that the polyol component (B) comprises at least one polyol with a hydroxyl number of 30 to 1000 and preferably of 500 to 1000 and an average hydroxy functionality per molecule of 2 to 7 and preferably of 2 to 4.

25. The multicomponent, in situ foaming system of claim 24, characterized in that the polyol component (B comprises at least one polyether polyol and/or polyester polyol with a hydroxyl number of 300 to 1000 and preferably of 500 to 1000 and an average hydroxy functionality of 2 to 7 and preferably of 2 to 4 and/or at least one amino polyether polyol and/or a polyol based on phosphate esters with a hydroxyl number of 30 to 1000 and preferably of 100 to 300 and an average hydroxy functionality per molecule of 2 to 7 and preferably of 3 to 5.

26. The multicomponent, in situ foaming system of claim 1, characterized in that the characteristic number of the polyurethane reaction ranges from 95 to 165 and preferably from 102 to 120.

27. The multicomponent, in situ foaming system of claim 1, characterized in that the polyol component (B) contains water in an amount, which results in a polyurethane foam with a foam density of 0.05 to 0.5 g/cc and preferably of 0.2 to 0.4 g/cc, one or more catalysts for the polyurethane-forming reaction, the component (D) for the formation of the further polymer and optionally a foam cell stabilizer.

28. The multicomponent, in situ foaming system of claim 27, characterized in that the polyol component (B) contains one or more tertiary amines, preferably dimorpholine diethyl ether, as catalyst for the polyurethane-forming reaction.

29. The multicomponent, in situ foaming system of claim 27, characterized in that the polyol component (B), as component (D) for the formation of the further polymer based on an epoxide resin, contains a conventional catalyst for the polymerization of the epoxide resin, preferably a tertiary amine, a Lewis acid, preferably a phenol, especially 2,4,6-tris(dimethylaminomethyl)-phenol.

30. The multicomponent, in situ foaming system of claim 27, characterized in that the polyol component (B), as component (D) for the formation of the further polymer based on a siloxane prepolymer, contains a conventional cross-linking agent for the siloxane prepolymer, preferably an organosiloxane with at least three methoxy groups per molecule.

31. The multicomponent, in situ foaming system of claim 27, characterized in that the polyol component (B) contains a polysiloxane as foam cell stabilizer.

32. The multicomponent, in situ foaming system of claim 1, characterized in that the components (A), (B), (C) and/or (D) contain conventional fillers, auxiliary materials and/or additives in the usual amounts.

33. The multicomponent, in situ foaming system of claim 30, characterized in that it contains 0 to 40% by weight and preferably 1 to 20% by weight of a filler, selected from sand, chalk, perlite, carbon black or mixtures thereof, 0 to 2% by weight and preferably 0.1 to 1% by weight of one or more pigments or dyes and/or 0 to 40% by weight and preferably 1 to 20% by weight of a flame retardant additive, in each case based on the weight of the in situ foaming system.

34. The multicomponent system of claim 1, characterized in that the mixtures, containing the components (A) to (D), are present in one or two separate containers, which is or are connected over supplying pipelines with a delivery device having a mixing head, for mixing and bringing the components (A) to (D) into contact and for discharging the foaming reaction mixture formed.

35. The multicomponent, in situ foaming system of claim 34, characterized in that the delivery device comprises a mixing head in the form of a nozzle with a static mixer.

36. The multicomponent, in situ foaming system of claims 34 or 35, characterized in that the container or containers is/are provided with extrusion devices for delivering the mixture or mixtures containing the components (A) to (D) into the mixing head of the delivery device.

37. The multicomponent, in situ foaming system of claim 36, characterized in that, as extrusion devices, mechanical pressing devices and/or propellant gases, which are contained in the polyisocyanate component (A) and the polyol component (B) and/or in the pressure chamber of a two-chamber cartridge, are present.

38. Method for sealing openings and/or bushings in walls and/or ceilings of buildings, characterized in that the multicomponent, in situ foaming system of claim 1, after destruction of the microcapsules containing the micro-encapsulated components (A) to (D) with the help of a delivery device with mixing head, in which the components are mixed, is brought into the opening and/or bushing and, with formation of an interpenetrating, polymeric network (IPN) of foamed polyurethane and at least one further polymer, is allowed to foam up and cure.

39. A structure having cracks or fissures filled with a material conforming to the multicomponent foaming system of claim 1, said material having been treated pursuant to the method of claim 38.

40. The multicomponent, in situ foaming system of claim 17, characterized in that, as component (D) for forming the further polymer based on an epoxide resin, a conventional catalyst for the polymerization of the epoxide resin, preferably a tertiary amine, a Lewis acid, preferably a phenol, particularly 2,4,6-tris(dimethylaminomethyl)-phenol is contained, optionally in a micro-encapsulated form.

41. The multicomponent, in situ foaming system of claim 18, characterized in that, as component (D) for the formation of the further polymer on the basis of a siloxane prepolymer, a conventional cross-linking agent for the siloxane prepolymer, preferably an organosiloxane with at least three methoxy end groups per molecule, is contained, optionally in micro-encapsulated form.
